(19) United States
(12) Patent Application Publication
(10) Pub. No.: US 2017/0244525 A1
(43) Pub. Date: Aug. 24, 2017

(54) RESOURCE ALLOCATION

(71) Applicant: FUJITSU LIMITED, KAwasaki-shi, Kanagawa (JP)

(72) Inventor: Chenxi ZHU, Fairfax, VA (US)

(73) Assignee: FUJITSU LIMITED, Kawasaki-shi, Kanagawa (JP)

(21) Appl. No.: 15/309,786

(22) PCT Filed: Mar. 5, 2015
(86) PCT No.: PCT/US2015/018983

§ 371 Date: Nov. 8, 2016

Related U.S. Application Data
(60) Provisional application No. 61/990,440, filed on May 8, 2014.

(51) Int. Cl. H04L 5/00; H04W 72/04

(52) U.S. Cl. CPC H04L 5/0037; H04W 72/04

(57) ABSTRACT

A method may include allocating transmission resource patterns among multiple terminals. The transmission resource patterns may be associated with vectors from multiple matrices. Each element of the matrices may correspond to a different frequency-domain resource unit and each element position within the vector may correspond to a different time-domain resource unit. Each of the elements may occur at least twice within each matrix of the multiple matrices. Each element of each matrix of the multiple matrices may be unique relative to each other element of the same column of the same matrix and may be unique relative to each other element of the same row of the same matrix.

### CROSS-REFERENCE TO RELATED APPLICATIONS

This patent application claims priority to U.S. Provisional Application No. 61/990,440, filed May 8, 2014, which is incorporated herein by reference in its entirety.

### FIELD

The embodiments discussed herein are related to resource allocation.

### BACKGROUND

Device-to-device (D2D) communication may allow data transmissions to be made directly between two or more devices or terminals of a telecommunication system. The D2D communication may overlay regular cellular communications, and/or may be performed with or without cellular network coverage.

In some instances, allowing D2D communication in a telecommunication network may increase network capacity. For example, D2D communication may permit spatial multiplexing, which may allow for higher relative spectrum usage. Employing D2D communication may also permit throughput between devices to be increased if a D2D link experiences better channel quality than a cellular link. Using D2D communication may reduce resource usage when data is transmitted once between two devices during a D2D transmission, as compared to transmitting the same data twice between the two devices over a cellular link, e.g., once through an uplink (UL) transmission from a transmitting terminal to a base station and once through a downlink (DL) transmission to a receiving terminal from the base station.

In some cases, D2D communication may reduce communication latency of a telecommunication network. For example, D2D communication may not relay data through a base station and/or a core network, thus potentially reducing the transit time of the data and/or the load on the base station and/or the core network.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include allocating transmission resource patterns among multiple terminals. The transmission resource patterns may be associated with vectors from multiple matrices. Each element of the matrices may correspond to a different frequency-domain resource unit and each element position within the vector may correspond to a different time-domain resource unit. Each of the elements may occur at least twice within each matrix of the multiple matrices. Each element of each matrix of the multiple matrices may be unique relative to each other element of the same column of the same matrix and may be unique relative to each other element of the same row of the same matrix.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a diagram of an example telecommunication system;

FIG. 2 illustrates an example of four mutually orthogonal Latin squares;

FIG. 3 is a flowchart of an example method of allocating resources; and

FIG. 4 is a flowchart of an example method of transmitting a D2D communication.

### DESCRIPTION OF EMBODIMENTS

Reducing interference between terminals performing device-to-device (D2D) communication within a telecommunication system may include a base station assigning different frequency-domain and time-domain resources for D2D communication to each terminal associated with the base station. However, different base stations may not coordinate their resource allocation with neighboring base stations. Alternately or additionally, terminals not associated with a base station may transmit D2D communication via resources selected by the terminals without coordination with nearby base stations. Thus, for example, a scenario may arise where, even if each of the base stations assigns non-interfering resources for D2D communication to the terminals within its cell, the D2D communication from other terminals may potentially cause interference.

Some embodiments described herein may relate to allocating transmission resource patterns among multiple terminals of a telecommunication system. The transmission resource patterns may be used for D2D communication between the terminals. The transmission resource patterns may be associated with vectors from multiple matrices. The multiple matrices may be configured such that interference over D2D communication resources may be manageable, predictable, and/or kept relatively low.

Some embodiments described herein may relate to a telecommunication system based on the 3rd Generation Partnership Project's (3GPP) Long Term Evolution (LTE) radio access network. Descriptions involving LTE may also apply to 3GPP's Long Term Evolution Advanced (LTE-A) radio access network. However, the embodiments described herein are not limited to the example telecommunication systems described. Rather, the embodiments described herein may also be applicable to other telecommunication systems.

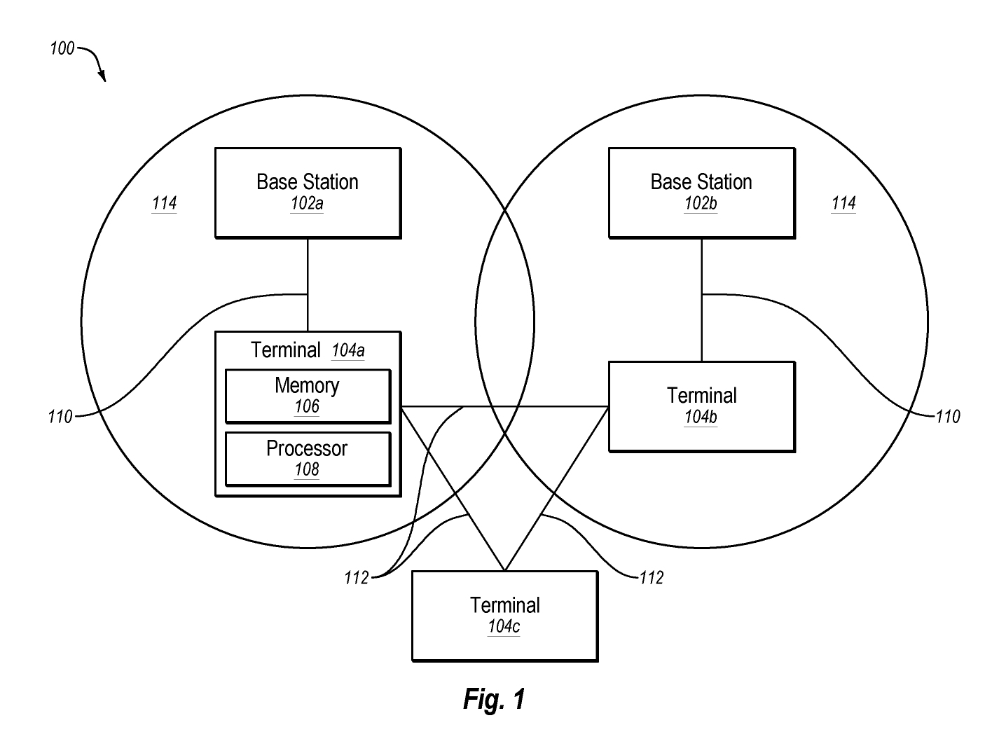

FIG. 1 is a diagram of an example telecommunication system 100. Network architecture of the telecommunication system 100 may include the network architecture of an Evolved Universal Mobile Telecommunications System (E-UMTS). The E-UMTS may include an LTE radio access network, for instance. The radio access network may include an E-UMTS Terrestrial Radio Access Network (E-UTRAN). However, other types of network architecture may alternately or additionally be used.

In some embodiments, the telecommunication system 100 may include a base station 102a and/or a base station 102b (collectively “base stations 102”). The base stations 102 may each be associated with a cell 114. The base stations 102 may include base station equipment, including hardware and/or software for radio communication with radio-communication-equipped nodes (“wireless nodes”). For example, the base stations 102 may be equipped for radio communication 110 with wireless nodes such as terminal 104a, terminal 104b, and terminal 104c (collectively “terminals 104”). The base stations 102 may generally allow the wireless nodes, including the terminals 104, to wirelessly communicate with each other and/or to wirelessly access a network (not shown) via radio communication 110 with the base stations 102.

The base stations 102 may include hardware and/or software for radio communication over a licensed spectrum. The licensed spectrum may generally include portions of a radio spectrum licensed for transmission of wireless data, such as cellular data. For example, the base stations 102 may be configured to transmit cellular data that complies with an LTE radio access network, such as an LTE radio access network according to 3GPP LTE specification releases 8-12. The base stations 102 may include an E-UTRAN NodeB (eNB) associated with LTE radio access networks.

The terminals 104 may include equipment configured to allow the terminals 104 to transmit and receive data via wireless communications via the licensed spectrum. For example, the terminals 104 may include hardware, such as one or more antennas for transmitting and receiving radio transmissions, and codecs. The terminals 104 may include mobile phones, tablet computers, laptop computers, and/or other electronic devices that may use radio communication. Alternately or additionally, the terminals 104 may include devices that employ machine-type communication (MTC). The terminals 104 may include user equipment (UE) associated with LTE radio access networks.

Each of the terminals 104 and/or each of the base stations 102 may include memory 106 and a processor 108. The memory 106 may include a non-transitory computer-readable medium. Instructions such as programming code executable by the processor 108 may be encoded in the memory 106. When the instructions are executed by the processor 108, the associated terminals 104 and/or the associated base stations 102 may perform operations related to and/or including the processes described herein.

The terminals 104 may be equipped for D2D communication 112. The D2D communication 112 may allow the terminals 104 to transmit and/or receive data among the terminals 104 without routing the data through the base stations 102. In some embodiments, the terminals 104 may be synchronized for D2D communication 112 by way of a D2D synchronization signal (D2DSS), a primary synchronization signal (PSS), a secondary synchronization signal (SSS), or the like. In some embodiments, the network may be synchronous, e.g., the base stations 102 and the terminals 104 (both inside and outside of network coverage) may be synchronized to the same timing reference.

The radio communication 110 and/or the D2D communication 112 may contribute to interference experienced in the telecommunication system 100. A radio communication channel of the telecommunication system 100 may experience interference when a receiver such as the base stations 102 and/or the terminals 104 experiences electromagnetic power from an unintended source that reduces the achievable rate of transmission. Some embodiments described herein may allow the interference experienced by the terminals 104 in D2D communication 112 to be managed, predicted, and/or reduced. In some embodiments, interference between terminals 104 from D2D communication 112 may be managed by way of one or more Latin squares.

In some embodiments, the telecommunication system 100 may support two modes of D2D communication 112. In a first D2D communication 112 mode (mode 1), resources for the D2D communication 112 may be allocated to the terminals 104 by the base stations 102. In a second D2D communication 112 mode (mode 2), the terminals 104 themselves may select resources for the D2D communication 112. In some embodiments, terminals within network coverage, e.g., the terminal 104a and the terminal 104b, may perform mode 1 D2D communication 112 and terminals outside of network coverage, e.g., the terminal 104c, may perform mode 2 D2D communication 112.

The D2D communication 112 from the terminals 104 may be transmitted with enough power to potentially interfere with the radio communication 110 and/or the D2D communication 112 between other terminals 104 and/or the base stations 102. For example, the terminals 104 may transmit the D2D communication 112 to target other terminals 104 within a −105 decibel milliwatt (dBm) link budget. When different D2D communications 112 are transmitted via the same frequency-domain and time-domain resources within a particular range, the different D2D communications 112 may cause interference, e.g., collisions, at the terminals 104 receiving the D2D communications 112.

In some embodiments, resources may be allocated to the terminals 104 for D2D communication 112 under mode 1 and/or mode 2 such that interference between the terminals 104 may be managed, predicted, and/or reduced. The D2D communication 112 resources may be allocated according to predefined resource patterns based on orthogonal Latin squares. Alternately or additionally, the D2D communication 112 resources may be allocated according to predefined resource patterns based on other matrices. In some embodiments, the terminals 104 may adjust a coding and modulation scheme for D2D communication 112 based on a perceived interference level to potentially increase the robustness of the D2D communication 112 transmissions.

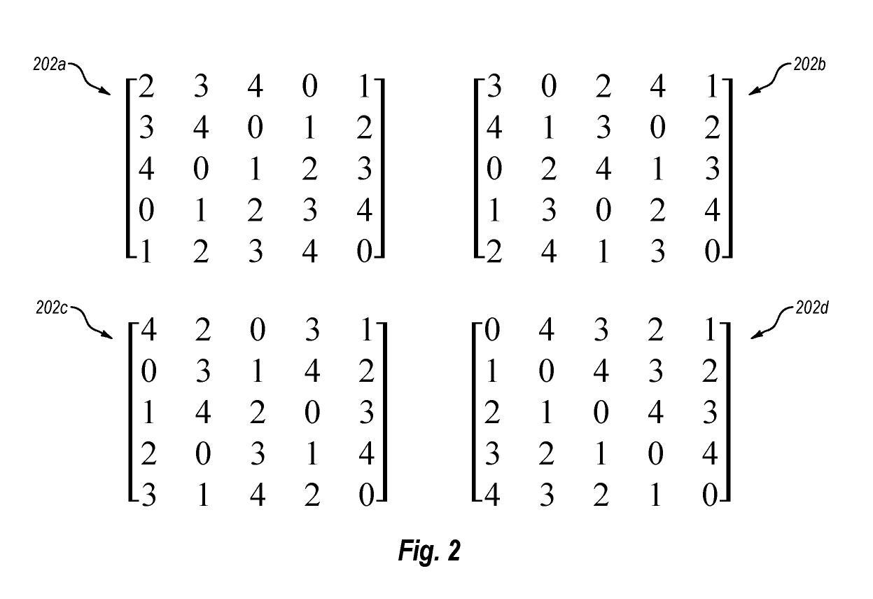

FIG. 2 illustrates an example of four mutually orthogonal Latin squares, including Latin square 202a, Latin square 202b, Latin square 202c, and Latin square 202d (collectively “Latin squares 202”). A Latin square may include an n×n matrix filled with n different elements. For example, a Latin square may include a 5×5 matrix filled with 5 different elements, such as elements 0, 1, 2, 3, and 4, as shown in FIG. 2. Each element may occur once in each row and once in each column. In some embodiments, n, e.g., the size of the Latin squares, may be defined as a network-wide parameter.

Two Latin squares may be orthogonal if each ordered pair of elements from the same respective location in the two Latin squares is distinct. For a given n, the number of mutually orthogonal Latin squares may be equal to or less than n-1. When n is equal to a prime number or a power of a prime number, the number of mutually orthogonal Latin squares may equal n-1. For example, for n=5, there may be 4 mutually orthogonal Latin squares, such as the Latin squares 202. In some embodiments, a prime number or a power of a prime number may be selected for n.

In some embodiments, each element of a Latin square, e.g., elements 0, 1, 2, 3, and 4 in the Latin squares 202, may represent a unique transmission resource unit in the frequency domain and/or the time domain. In some embodiments, each of the individual elements may be associated with a distinct set of physical resource blocks (PRBs). For example, the element 0 may be associated with a first set of PRBs, the element 1 may be associated with a second set of PRBs, and so on. Alternately or additionally, relative locations within the Latin squares 202 may represent one or more subframes in the time domain. For example, a first column of the Latin squares 202 may represent a first subframe, a second column of the Latin squares 202 may represent a second subframe, and so on. Thus, for example, the element 0 in the first column may represent the first set of PRBs during the first subframe.

With combined reference to FIGS. 1 and 2, in some embodiments, each row vector of the Latin squares 202 may represent a transmission resource pattern that may be assigned to one of the terminals 104 for D2D communication 112. The time resources of the row vectors may correspond to the time resources of the various columns of the Latin squares. For example, the first element of the row vector may be associated with the same subframes as the first columns of the Latin squares 202.

Alternately, each column vector of the Latin squares 202 may represent a transmission resource pattern. For example, the first row of the Latin squares 202 may represent a first subframe, a second row of the Latin squares 202 may represent a second subframe, and so on. As used herein, descriptions of row vectors may also apply to column vectors in embodiments where column vectors represent resource patterns.

By way of example, if the terminal 104a is assigned the row vector [2 3 4 0 1] from the Latin square 202a, the terminal 104a may transmit a D2D communication 112 via PRBs associated with element 2 during a first one or more subframes, via PRBs associated with element 3 during a second one or more subframes, via PRBs associated with element 4 during a third one or more subframes, via PRBs associated with element 0 during a fourth one or more subframes, and/or via PRBs associated with element 1 during a fifth one or more subframes. If terminal 104b is further assigned the row vector [3 4 0 1 2] from the Latin square 202a, the terminal 104b may transmit a D2D communication 112 via PRBs associated with element 3 during the first one or more subframes, via PRBs associated with element 4 during the second one or more subframes, and so on. In some embodiments, the terminals 104 may code the D2D communication 112 across the n resource units for robustness.

Thus, for example, resources for D2D communication 112 may be allocated according to row vectors of the Latin squares 202. Resources corresponding to two rows of a same Latin square, such as the Latin square 202a, may be orthogonal, e.g., the D2D communication 112 transmissions may occupy different PRBs during the same subframes.

For example, each element of the Latin square 202a may appear once per column, such that the same PRBs may not be used for D2D communication 112 transmissions during the same subframe when the resources for D2D communication 112 are allocated from the same Latin square.

Resources corresponding to two rows of different, mutually orthogonal Latin squares, such as the Latin square 202a and the Latin square 202b, may occupy the same PRBs during one in n subframes. For example, the first row of the Latin square 202a and the first row of the Latin square 202b may include the same fifth element (1), the first row of the Latin square 202a and the second row of the Latin square 202b may include the same fourth element (0), and so on. Conversely, resources corresponding to the two rows may occupy different PRBs during n-1 in n subframes.

The transmission resource patterns, e.g., the row vectors of the Latin squares 202, may be allocated by an eNB, such as by the base stations 102. In some embodiments, the base stations 102 may receive a Latin square through a network X2 interface associated with LTE networks. Alternately or additionally, the base stations 102 may generate or otherwise choose a Latin square. For example, an isolated femtocell base station may choose a Latin square. In some embodiments, base stations 102 that are relatively close to one another may be assigned mutually orthogonal Latin squares. For example, mutually orthogonal Latin squares may be assigned to relatively close base stations 102 as part of network planning Alternately or additionally, base stations 102 that are relatively close and that may coordinate D2D communication 112 resource allocation may be assigned the same Latin square.

In some embodiments, the transmission resource patterns may be allocated to the terminals 104 via radio resource control (RRC) signals and/or system information block (SIB) signals from the base stations 102.

In some embodiments, mode 1 terminals 104, such as the terminal 104a and the terminal 104b, may be assigned D2D communication 112 resources based on the base stations' Latin squares. In some embodiments, each of the base stations 102 may identify its Latin square to its associated terminals 104. For example, the Latin square 202a may be assigned to the base station 102a, which may identify the Latin square 202a to its terminals, including the terminal 104a. The Latin square 202b may be assigned to the base station 102b, which may identify the Latin square 202b to its terminals, including the terminal 104b. The Latin squares 202a and 202b may be identified to the terminals 104 as part of SIB or RRC signaling. In some embodiments, the Latin squares 202a and 202b may be identified by transmitting a signal including an index or other identifier of the Latin square for identifying the Latin square from multiple Latin squares stored on the terminals 104.

Each of the base stations 102 may assign D2D communication 112 transmission resources corresponding to one or more rows of its Latin square. In some embodiments, the base stations 102 may assign a row of a Latin square to the terminals 104 associated with the base stations 102. In some embodiments, the row assignments to the terminals 104 may be signaled in a Physical Downlink Control Channel (PDCCH) or an Enhanced Physical Downlink Control Channel (ePDCCH). In some embodiments, where the terminals know the identity of the Latin square, the base stations 102 may signal an index of the row of the Latin square corresponding to the D2D communication 112 resources assigned to the terminals 104. A particular base station, such as the base station 102a may assign D2D communication 112 resources corresponding to different rows of its Latin square to different terminals 104 associated with the base station 102a.

In some embodiments, the base stations 102 may not coordinate when assigning resources to their respective terminals 104. In this and other embodiments, the interference between terminals 104 associated with different base stations 102 may be well controlled by using D2D communication 112 resources based on different, mutually orthogonal Latin squares.

In some embodiments, neighboring base stations 102, such as the base station 102a and the base station 102b may coordinate D2D communication 112 resource assignments. In this and other embodiments, the base stations 102 may use a single, shared Latin square. The D2D communication 112 resources allocated to different terminals 104 under the collective control of the base stations 102 may be based on different rows of the shared Latin square and may thus be orthogonal. By way of example, when the base station 102a assigns a first vector from a shared Latin square to the terminal 104a for D2D communication 112, the base station 102a may identify the first vector to the base station 102b so the base station 102b may assign a different vector to the terminal 104b for D2D communication 112.

In some embodiments, mode 2 terminals 104, such as the terminal 104c, may autonomously select resources in a distributed matter using default pre-configured Latin squares. If the terminals 104 operating in mode 2 use resources from the same resource pool as may be assigned to the terminals 104 operating in mode 1, the default pre-configured Latin squares used by the terminals 104 in mode 2 may be different and mutually orthogonal relative to the Latin squares of the base stations 102.

In some embodiments, mode 2 terminals 104 may synchronize via a D2D synchronization channel (PD2DSCH) associated with an independent D2DSS. The PD2DSCH and/or the D2DSS may be transmitted by one or more of the mode 2 terminals 104. The independent PD2DSCH may include an index indicating a Latin square for mode 2 D2D communication 112, such as the Latin square 202c.

In some embodiments, the terminals 104 may be configured with multiple candidate Latin squares 202 for use in transmitting mode 2 D2D communication 112. In some embodiments, one of the terminals 104 operating in mode 2 may become an independent synchronization source and may choose one of the Latin squares 202 to be identified in the PD2DSCH. In some embodiments, when the mode 2 terminals 104 synchronize to a D2DSS, the mode 2 terminals 104 may adopt the Latin square identified in the PD2DSCH channel. The terminals 104 may select their D2D communication 112 resources from vectors of the identified Latin square.

In some embodiments, one or more Latin squares may be pre-configured for the terminals 104 to use in selecting resources for mode 2 D2D communications 112. In some embodiments, mode 2 terminals 104, such as the terminal 104c, may select resources for D2D communications by selecting resources corresponding to a row of the preconfigured Latin square. For example, the terminal 104c may select a row of the Latin square randomly. Alternately, the terminal 104c may select a row of the Latin square based on channel measurements. In some embodiments, the terminal 104c may measure the interference in the resources associated with each row vector of the Latin square, e.g., the terminal 104c may measure the interference associated with each transmission resource pattern, and may select a row associated with resources over which the terminal 104c may experience relatively low interference and/or the lowest relative interference.

By way of example, an interference analysis of D2D communication 112 transmission resource usage for the terminal 104a, the terminal 104b, and the terminal 104c may be demonstrated in the following table. As indicated in the below table, the terminal 104a may be assigned D2D communication 112 resources associated with the first row of the Latin square 202a, the terminal 104b may be assigned D2D communication 112 resources associated with the first row of the Latin square 202b, and the terminal 104c may select the second row of the Latin square 202c for D2D communication 112.

| | Time (subframes) | | | | |
|---|---|---|---|---|---|
| | 1 | 2 | 3 | 4 | 5 |
| Terminal 104a | 2 | 3 | 4 | 0 | 1 |
| Terminal 104b | 3 | 0 | 2 | 4 | 1 |
| Terminal 104c | 0 | 3 | 1 | 4 | 2 |

Each pair of D2D communication 112 transmissions from the terminals 104 may collide once in n subframes. For example, the terminal 104a and the terminal 104b may collide in the fifth subframe via the PRBs associated with the element 1. The terminal 104a and the terminal 104c may collide in the second subframe via the PRBs associated with the element 3. The terminal 104b and the terminal 104c may collide in the fourth subframe via the PRBs associated with the element 4. Thus, for example, without coordination between the base stations 102 and the terminal 104c, the D2D communication 112 transmissions of each of the terminals 104 may not collide in 3 of 5 resource units. In some embodiments, the interference among the terminals 104 may be predictable, relatively manageable, and potentially reduced relative to other techniques for assigning resources for D2D communication 112.

Although some embodiments may employ Latin squares as a source of pre-configured resource patterns, other patterns may alternately or additionally be used. In some instances, matrices having properties similar to the properties of Latin squares may be used. For example, resource pattern matrices may result in orthogonal resource usage when resources are selected from a same base matrix. Interference may likewise be controlled when resources are selected from different base matrices.

Signaling for a non-Latin square matrix may be the same or similar to signaling for a Latin square matrix. For example, signaling may indicate an index of a matrix to be used and may indicate an index of a row or column vector representing the resource pattern to be employed in D2D communications.

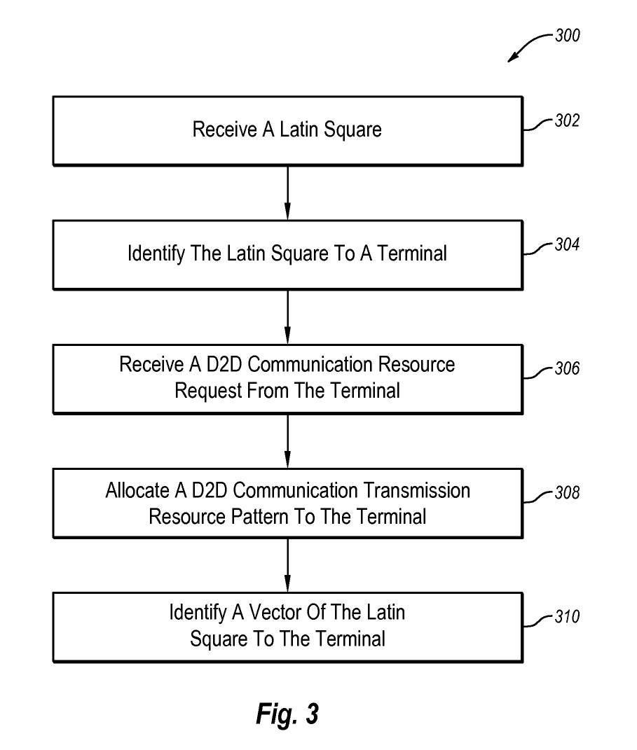

FIG. 3 illustrates a flowchart of an example method 300 of allocating resources. In some embodiments, the method 300 may be performed by the base stations 102 of FIG. 1.

The method 300 may begin at block 302 by receiving a Latin square. The Latin square may be one of multiple mutually orthogonal Latin squares. For example, the Latin square may generally correspond to one of the mutually orthogonal Latin squares 202 of

FIG. 2. In some embodiments, the Latin square may be received along with the multiple mutually orthogonal Latin squares and the Latin square may be chosen by the base station. For example, an isolated base station may choose its own Latin square from the multiple mutually orthogonal Latin squares. Alternately or additionally, the base station may create a Latin square. In some embodiments, the Latin square may be configured through an X2 interface. Alternately or additionally, the Latin square may be assigned as part of network planning

The method 300 may continue at block 304 by identifying the Latin square to a terminal. The terminal may generally correspond to the terminals 104a and 104b of FIG. 1. In some embodiments, the Latin square may be identified by a base station signaling. For example, the Latin square may be identified through RRC signals and/or SIB signals. In some embodiments, the Latin square may be identified via an index associated with the Latin square. Alternately or additionally, the configuration of the Latin square may be communicated to the terminal.

The method 300 may continue at block 306, by receiving a D2D communication resource request from the terminal.

The method 300 may continue at block 308, by allocating a D2D communication transmission resource pattern to the terminal based on a vector of the Latin square.

The method 300 may continue at block 310, by identifying to the terminal the vector of the Latin square corresponding to the D2D communication transmission resource pattern allocated to the terminal. In some embodiments, identifying to the terminal the vector of the Latin square may include identifying an index of the Latin square associated with the vector. For example, if a D2D communication transmission resource pattern is based on the top row vector of the Latin square, the row vector may be identified by the index of the top row (e.g., 0 or 1, depending on the numbering convention). In some embodiments, the vector and/or the index of the vector may be signaled to the terminal in the PDCCH and/or the ePDCCH.

For this and other processes and methods disclosed herein, the functions performed in the processes and methods may be implemented in differing order. Furthermore, the outlined operations are provided only as examples, and some of the operations may be optional, combined into fewer operations, or expanded into additional operations without detracting from the essence of the embodiments.

For example, in some embodiments, the method 300 may further include a terminal indicating the D2D communication transmission resource pattern the terminal may use for a D2D communication transmission. The terminal may generally correspond to the terminal 104c of FIG. 1. For example, the terminal may indicate the D2D communication transmission resource pattern to another terminal to which the terminal intends to transmit D2D communication transmissions. In some embodiments, the terminal may indicate the D2D communication transmission resource pattern via an index associated with the Latin square and/or an index associated with the relevant vector of the Latin square.

In some embodiments, the method 300 may be performed by a first base station and with a first terminal, and the method 300 may further include assigning the same Latin square to a second base station configured to communicate with the first base station. For example, the first base station and the second base station may be configured to communicate via an X2 interface. Alternately or additionally, the method 300 may include the first base station communicating to the second base station the allocation of the D2D communication transmission resource pattern to the first terminal. For example, the first base station may communicate the index of the Latin square associated with the first vector via the X2 interface.

Alternately or additionally, the method 300 may include identifying the Latin square to a second terminal associated with the second base station. Alternately or additionally, the method 300 may include receiving a D2D communication resource request from the second terminal. For example, the method 300 may include receiving the D2D communication resource request at the second base station.

Alternately or additionally, the method 300 may include allocating to the second terminal a second D2D communication transmission resource pattern corresponding to a second vector of the Latin square. For example, the method 300 may include the second base station allocating the second D2D communication transmission resource pattern corresponding to the second vector of the Latin square. The second vector of the Latin square may be different from the first vector. Thus, for example, the second base station may avoid allocating the same D2D communication transmission resource pattern as allocated by the first base station.

Alternately or additionally, the method 300 may include identifying the second vector of the Latin square to the second terminal. For example, the method 300 may include the second base station identifying the second vector to the second terminal. In some embodiments, identifying the second vector to the second terminal may include identifying a second index of the Latin square associated with the second vector.

Alternately or additionally, the method 300 may include the second base station communicating the allocation of the second D2D communication transmission resource pattern to the first base station. For example, the second base station may communicate the index of the Latin square associated with the second vector via the X2 interface.

In some embodiments, the method 300 may further include assigning a second Latin square from the multiple mutually orthogonal Latin squares to a second base station. Alternately or additionally, the method 300 may include the second base station identifying the second Latin square to the second terminal. Identifying the second Latin square to the second terminal may generally correspond to identifying the first Latin square to the first terminal. Alternately or additionally, the method 300 may include the second base station identifying a vector of the second Latin square to the second terminal. Identifying the vector of the second Latin square to the second terminal may generally correspond to identifying the vector of the first Latin square to the first terminal.

In some embodiments, the method 300 may further include assigning a second Latin square from the multiple mutually orthogonal Latin squares to a second terminal associated with mode 2 D2D communication. The second terminal may be configured to select a vector of the second Latin square as a D2D communication transmission resource pattern for the second terminal. In some embodiments, the second terminal may select the vector from the second Latin square randomly. Alternately, the second terminal may select the vector from the second Latin square based on channel measurements of the D2D communication transmission resources associated with each of the vectors of the second Latin square. For example, the second terminal may select the vector associated with a relatively low detected interference on the associated resources.

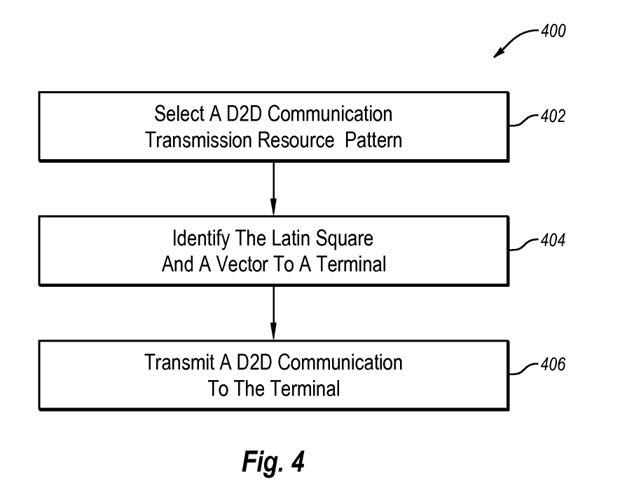

FIG. 4 illustrates a flowchart of an example method 400 of transmitting a D2D communication. In some embodiments, the method 400 may be performed by a terminal such as the terminal 104c of FIG. 1 for transmitting D2D communications under mode 2. In some embodiments, the terminal may be configured with one or more candidate Latin squares from multiple mutually orthogonal Latin squares. For instance, the terminal may have stored thereon one or more candidate Latin squares from multiple mutually orthogonal Latin squares. If the terminal is configured with multiple candidate Latin squares, the method 400 may include selecting one of the Latin squares. In some embodiments, other Latin squares of the multiple mutually orthogonal Latin squares may be assigned to base stations.

The method 400 may begin at block 402, by selecting a D2D communication transmission resource pattern. The D2D communication transmission resource pattern may correspond to a vector of a Latin square. In some embodiments, the method 400 may further include measuring channel interference of the D2D communication transmission resource patterns corresponding to the vectors of the Latin square and selecting the D2D communication transmission resource pattern based on the channel measurements. For example, a D2D communication transmission resource pattern with relatively low interference may be selected.

The method 400 may continue at block 404, by identifying the Latin square and the vector corresponding to the selected D2D communication transmission resource pattern to a terminal configured for D2D communication. For example, a first terminal performing the method 400 may identify the Latin square and the vector to a second terminal to which the first terminal intends to transmit D2D communication transmissions.

The method 400 may continue at block 406, by transmitting a D2D communication to the terminal. The D2D communication may be transmitted via the selected D2D communication transmission resource pattern.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general-purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method comprising:
allocating transmission resource patterns among a plurality of terminals, the transmission resource patterns associated with vectors from a plurality of matrices, wherein each element of each of the vectors corresponds to a different frequency-domain resource unit, and each element position within the vector corresponds to a different time-domain resource unit;
wherein:
each of the elements occurs at least twice within each matrix of the plurality of matrices,
each element of each matrix of the plurality of matrices is unique relative to each other element of the same column of the same matrix, and
each element of each matrix of the plurality of matrices is unique relative to each other element of the same row of the same matrix.

2. The method of claim 1, wherein each of the elements appears once in each row of each matrix of the plurality of matrices and once in each column of each matrix of the plurality of matrices.

3. The method of claim 1, wherein the plurality of matrices comprises a plurality of mutually orthogonal Latin squares.

4. The method of claim 3, wherein each Latin square of the plurality of mutually orthogonal Latin squares includes an n×n matrix, wherein n equals a prime number or a power of a prime number, and the plurality of mutually orthogonal Latin squares includes n-1 mutually orthogonal Latin squares.

5. The method of claim 1, wherein the elements of each of the plurality of matrices are arranged such that each ordered pair of elements from each of the same respective locations in any pair of the matrices of the plurality of matrices is distinct.

6. The method of claim 1, further comprising identifying a first matrix of the plurality of matrices to a first terminal of the plurality of terminals.

7. The method of claim 6, wherein allocating the transmission resource patterns includes a base station assigning a first transmission resource pattern corresponding to a first vector of the first matrix to the first terminal by identifying an index corresponding to the first vector to the first terminal.

8. The method of claim 7, wherein the identifier is transmitted by the base station via a radio resource control signal or a system information block signal.

9. The method of claim 1, wherein allocating the transmission resource patterns includes a first terminal of the plurality of terminals selecting a first vector of a first matrix of the plurality of matrices and wherein the first vector corresponds to a first transmission resource pattern.

10. The method of claim 9, wherein the first vector is selected randomly by the first terminal.

11. The method of claim 9, wherein the first vector is selected based on channel measurements of the first transmission resource pattern taken by the first terminal.

12. A method comprising:
receiving a first Latin square of a plurality of mutually orthogonal Latin squares;
identifying the first Latin square to a first terminal;
receiving a device-to-device communication resource request from the first terminal;
allocating a first device-to-device communication transmission resource pattern to the first terminal, the first device-to-device communication transmission resource pattern corresponding to a first vector of the first Latin square; and
identifying the first vector of the first Latin square to the first terminal.

13. The method of claim 12, wherein the first Latin square is received by a first base station and the first terminal is associated with the first base station, the method further comprising:
assigning the first Latin square to a second base station;
communicating the allocation of the first device-to-device communication transmission resource pattern to the second base station;
identifying the first Latin square to a second terminal associated with the second base station;
receiving a device-to-device communication resource request from the second terminal;
allocating a second device-to-device communication transmission resource pattern to the second terminal, the second device-to-device communication transmission resource pattern corresponding to a second vector of the first Latin square that is different than the first vector of the first Latin square;
identifying the second vector of the first Latin square to the second terminal; and
communicating the allocation of the second device-to-device communication transmission resource pattern to the first base station.

14. The method of claim 12, wherein the first Latin square is received by a first base station and the first terminal is associated with the first base station, the method further comprising:
assigning a second Latin square of the plurality of mutually orthogonal Latin squares to a second base station;
identifying the second Latin square to a second terminal associated with the second base station;
receiving a device-to-device communication transmission resource request from the second terminal;
allocating a second device-to-device communication transmission resource pattern to the second terminal, the second device-to-device communication transmission resource pattern corresponding to a second vector of the first Latin square; and
identifying the second vector of the second Latin square to the second terminal.

15. The method of claim 12, further comprising:
assigning a second Latin square of the plurality of mutually orthogonal Latin squares to a second terminal associated with device-to-device communication performed outside of network coverage, the second terminal configured to select a second vector of the second Latin square such that a second device-to-device communication transmission resource pattern corresponding to the second vector is adopted by the second terminal.

16. The method of claim 15, wherein the second terminal is further configured to randomly select the second vector from the second Latin square.

17. The method of claim 15, wherein the second terminal is further configured to select the second vector from the second Latin square based on channel measurements of the device-to-device communication transmission resources associated with each of the vectors of the second Latin square.

18. A method comprising:
selecting a device-to-device communication transmission resource pattern corresponding to a vector of a Latin square of a plurality of mutually orthogonal Latin squares;
identifying the Latin square and the vector to a terminal configured for device-to-device communication; and
transmitting a device-to-device communication transmission to the terminal via the selected device-to-device communication transmission resource pattern.

19. The method of claim 18, wherein the device-to-device communication transmission resource pattern is selected based on channel measurements of device-to-device communication transmission resource patterns corresponding to the vectors of the Latin square.

20. The method of claim 18, wherein identifying the Latin square and the vector includes transmitting a signal including an index of the Latin square and an index of the vector.
